(19) United States
(12) Patent Application Publication
(10) Pub. No.: US 2008/0055342 A1
(43) Pub. Date: Mar. 6, 2008

(54) METHOD FOR DISPLAYING A LOW-RESOLUTION IMAGE ON A HIGH-RESOLUTION DISPLAY DEVICE

(76) Inventor: Chien-Chuan Liao, Taipei County (TW)

Correspondence Address: NORTH AMERICA INTELLECTUAL PROPERTY CORPORATION, P.O. BOX 506, MERRIFIELD, VA, 22116, US

(21) Appl. No.: 11/672,502

(22) Filed: Feb. 7, 2007

(30) Foreign Application Priority Data
Sep. 4, 2006 (TW) 095132627

(51) Int. Cl. G09G 5/02

(52) U.S. Cl. 345/698

(57) ABSTRACT

Frames are utilized to display an image of low resolution on a display device of high resolution. All scanlines utilized for generating the image are turned on to display the image data of the display area in a first frame, and part but not all of the scanlines not utilized for generating the image are turned on to display the blank data of the non-display area in the first frame. Thus, the blank data of the non-display area are displayed in multiple frames.

### BACKGROUND OF THE INVENTION

1. Field of the Invention

The present invention relates to a method for displaying images, and more particularly, to a method for displaying a low-resolution image on a high-resolution display device.

2. Description of the Prior Art

Display devices, such as cathode ray tube monitors, liquid crystal display panels, plasma display panels, and projectors, which can display static images or dynamic videos, are common electrical devices used in daily life. Different video formats have different resolutions. For example, the resolution of VGA (Video Graphics Array) format is 640*480; the resolution of SXGA (Super Extended Graphics Array) format is 1280*1024. In the situation where the resolution of the display device is different from the resolution of received input video images, the received input video images must first be scaled in order to display the video images correctly.

In the prior art, there are two familiar image scaling methods. The first image scaling method uses a frame buffer to register the received video frame, and the second image scaling method uses a line buffer to register a portion of scanlines in the received video data. The image scaling method that uses the frame buffer requires more hardware than the image scaling method using the line buffer, therefore prior art methods usually select the image scaling method using the line buffer as the preferred choice.

If a liquid crystal display according to the prior art displays a low-resolution image without scaling, the controller of the liquid crystal display can insert blank data during the delay of the input signal through the line buffer and the horizontal blanking area and the output signal in the horizontal direction, and shift the start position of the signal during the delay of the input signal through the line buffer and the vertical blanking area and the output signal in the horizontal direction so as to display the blank data. Thus, the low-resolution image can be displayed on the high-resolution liquid crystal display. However, the line buffers and the size of the vertical blanking area of the input signal limit the method mentioned above. If the vertical blanking area of the input signal is too large or the size of the line buffer is too small, the image cannot be displayed completely. Moreover, the response time of the liquid crystal capacitor also limits the amount of the blank data that can be inserted during the delay of the line buffers.

### SUMMARY OF THE INVENTION

The present invention provides a method for displaying a low-resolution image on a high-resolution display panel comprising displaying a first area comprising the image of a first frame by turning on all scanlines utilized for generating the image; and displaying a second area of the first frame by turning on a part but not all of the scanlines not utilized for generating the image; wherein the first area of the first frame and the second area of the first frame do not overlap.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram of an LCD according to the present invention.

FIG. 2 is a diagram of displaying a low-resolution image on a high-resolution display panel.

FIG. 3 to FIG. 4 show a first embodiment of the LCD displaying the image in FIG. 2.

FIG. 5 to FIG. 6 show a second embodiment of the LCD displaying the image in FIG. 2.

FIG. 7 to FIG. 9 show a third embodiment of the LCD displaying the image in FIG. 2.

### DETAILED DESCRIPTION

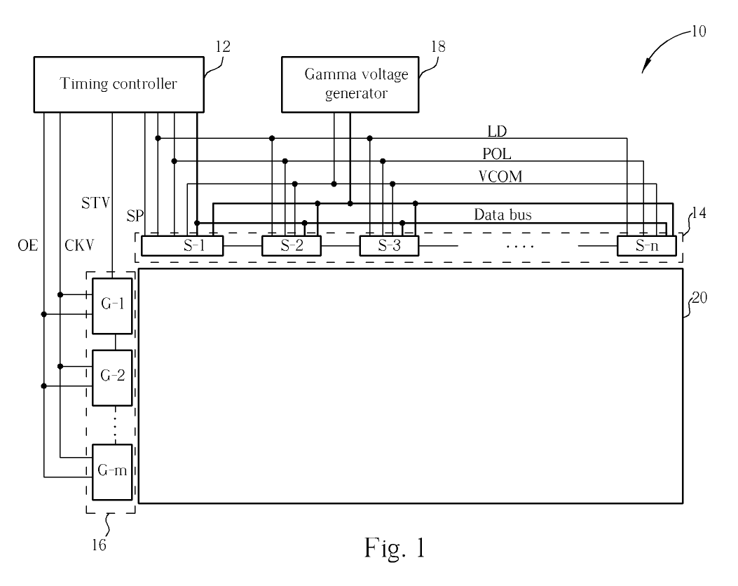

Please refer to FIG. 1. FIG. 1 is a diagram of an LCD 10 according to the present invention. The LCD 10 includes a display panel 20, a timing controller 12, a source driver 14, a gate driver 16, and a gamma voltage generator 18. The timing controller 12 provides clock signals to the source driver 14 and the gate driver 16. The gamma voltage generator 18 provides gamma reference voltages to the source driver 14. The number of output channels of the source drivers S1-Sn is the horizontal resolution of the display panel 20. For example, if the horizontal resolution of the display panel 20 is 1280, the source drivers S1-Sn have 1280*3 (RGB) channels to output data. Similarly, the number of output channels of the gate drivers G1-Gm is the vertical resolution of the display panel 20. The timing controller 12 outputs a start pulse SP and triggers the source driver 14 for transmitting data. The source driver 14 latches the image data from the data bus to the line buffer of the source driver 14 in a sequence according to the clock. Then, the timing controller 12 outputs a data-loading signal LD and triggers the source driver 14 for transmitting the image data to the output buffer of the source driver 14. Finally, the gate driver 16 turns on scanlines to transmit the image data to the display panel 20. Taking the first row of the image data as an example, after the source driver 14 receives the start pulse SP, the first row of the image data in the data bus being latched to the line buffer of the source driver 14, the source driver 14 receives the data-loading signal LD so as to transmit the first row of the image data to the output buffer of the source driver 14. For the gate driver 16, the timing controller 12 outputs a start signal STV and a gate clock signal CKV to trigger the gate driver 16 displaying the image data on the first row. In the meanwhile, the gate driver G1 latches the start signal STV to the buffer of the gate driver 16 according to the gate clock signal CKV, and turns on the first scanline with an output-enable signal OE so as to transmit the first row of the image data from the output buffer of the source driver 14 to the display panel 20. After displaying one row of the image data, the timing controller 12 outputs the gate clock signal CKV and shifts the start signal STV to the next row so as to turn on the next scanline and turn off the present scanline. In this way, the complete image frame can be displayed.

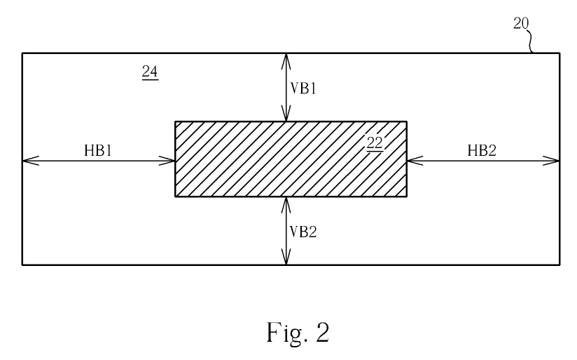

Please refer to FIG. 2. FIG. 2 is a diagram of displaying a low-resolution image in a high-resolution display panel 20. To display the low-resolution image in the high-resolution display panel 20, e.g. displaying a VGA (640*480) image on an SXGA (1280*1024) display panel, the display panel 20 has a blank area 24 on the periphery of a display area 22. The blank area 24 can be displayed as black data or any predetermined data. HB1, HB2, VB1, and VB2 are the respective distances from the edges of the display panel 20 to the display area 22, and also represent the size of the blank area 24. HB1, HB2, VB1, and VB2 can be adjusted as required, that is the display area 22 can be located anywhere on the display panel 20.

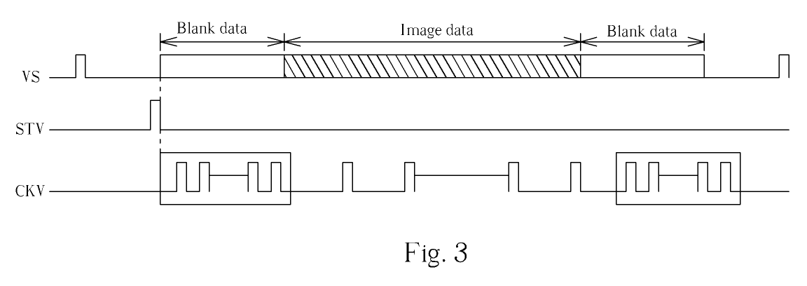

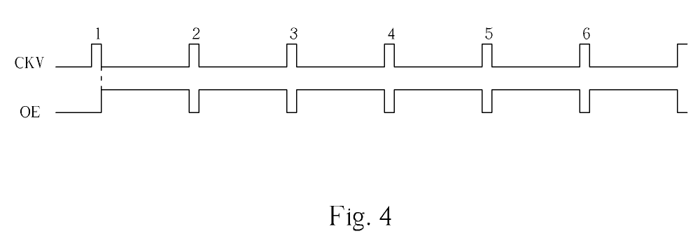

Please refer to FIG. 3 and FIG. 4, which show the first embodiment of the LCD 10 displaying the image in FIG. 2. As shown in FIG. 3, VS represents the display data of the display panel 20 in the vertical direction, including a blank area VB1, a display area 22, and a blank area VB2. STV represents the start signal of the timing controller 12 triggering the gate driver 16. CKV represents the gate clock signal. OE represents the output-enable signal. The gate clock signal CKV of the blank area 24 is as shown in FIG. 4. Each pulse of the gate clock signal CKV represents turning on one row of the scanline, and displaying one row of the blank data to the display panel 20 according to the output-enabling signal OE. Thus, the shorter the period of the gate clock signal CKV in the same vertical blank area 24, the more rows of the blank data can be inserted. The number of the pulses of the gate clock signal CKV represents the number of the scanlines; namely, the scanlines of the blank area 24 are turned on quickly and shifted to the scanlines of the display area 22. The period of the gate clock signal CKV of the blank area 24 can be adjusted according to the size of the blank area 24, but the time the output-enabling signal OE is turned on must be longer than the time the gate driver 16 is turned on, so that the blank data of the output buffer of the source driver 14 can be outputted to the liquid crystal capacitor correctly.

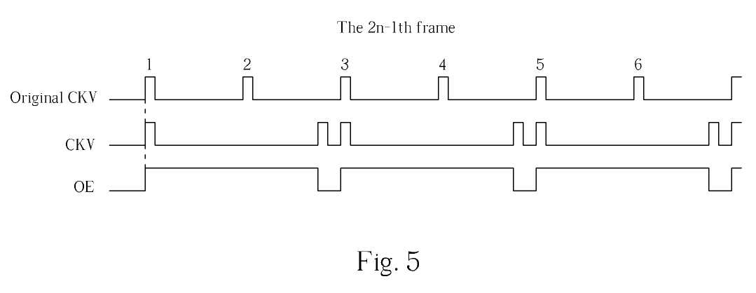

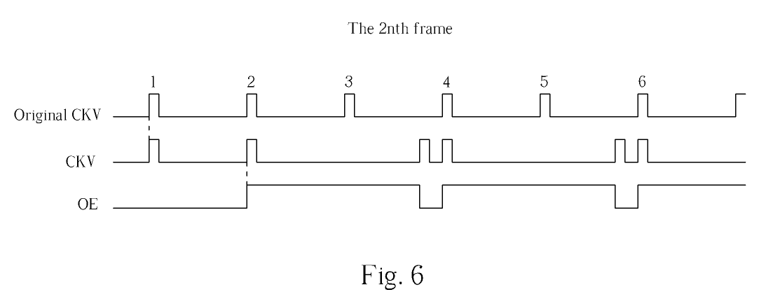

Please refer to FIG. 5 and FIG. 6, showing the second embodiment of the LCD 10 displaying the image in FIG. 2. The period of the gate clock signal CKV must be sufficiently long for the liquid crystal capacitor to be charged and react to the blank data. So, the amount of the blank data insertion is limited by the period between the input video signals unless more line buffers are added. The present invention utilizes a plurality of frames to insert the blank data displaying the blank area 24. In the second embodiment according to the present invention, the scanlines of the blank area 24 are divided into two groups. The first group of the scanlines includes the 2n−1th scanline, and the second group of the scanlines includes the 2nth scanline, where n is a positive integer. That is, the first group is odd scanlines, and the second group is even scanlines. The blank area 24 is shown in two frames. As shown in FIG. 5, in the 2n−1th frame, the first group utilized for the blank area 24 is turned on to display the blank data, and all scanlines utilized for the display area 22 to display the image are turned on. As shown in FIG. 6, in the 2nth frame, the second group utilized for the blank area 24 is turned on to display the blank data, and all scanlines utilized for the display area 22 are turned on to display the image. When the blank area 24 is shown with two frames, the amount of the blank data insertion is double for the same number of line buffers and the same liquid crystal response time. In FIG. 5, the 2nth pulse of the original gate clock signal CKV is shifted adjacent to the next pulse, and the output-enable signal OE turns off at the 2nth pulse. Thus, the 2nth scanline does not display the blank data and the 2n−1th scanline can turn on long enough for the liquid crystal capacitor to react to the blank data. Similarly, in FIG. 6, the 2n−1th pulse of the original gate clock signal CKV is shifted adjacent to the next pulse, and the output-enable signal OE turns off at the 2n−1th pulse, so that the 2nth scanline can turn on long enough for the liquid crystal capacitor to react to the blank data.

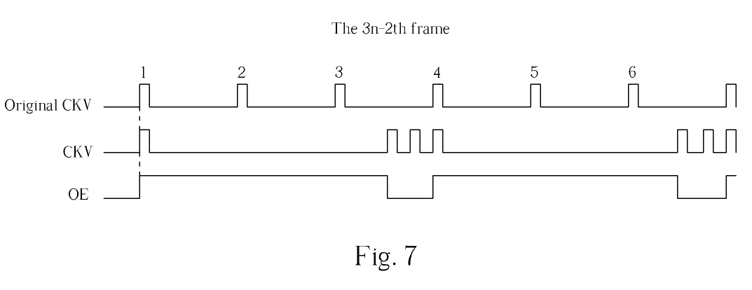

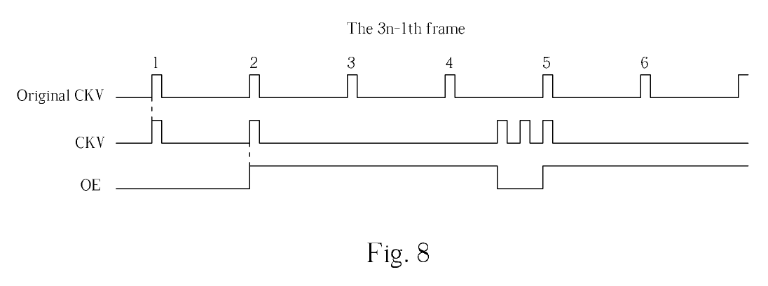

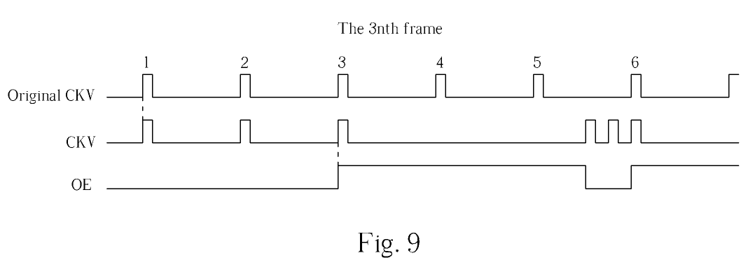

Please refer to FIG. 7 to FIG. 9, which show the third embodiment of the LCD 10 displaying the image in FIG. 2. When the blank area 22 is very large, which means the resolution of the display panel 20 is much higher than the image, two frames cannot display the blank area 24 due to the limitation of the line buffer and the reaction of the liquid crystal capacitor, so the scanlines utilized for generating the blank area 24 can be further divided into three or four groups, corresponding to three or four frames to display. The third embodiment according to the present invention illustrates displaying the blank area 24 with three groups of the scanlines correspond to three frames. As shown in FIG. 7, in the 3n−2th frame, the 3n−1th and the 3nth pulse of the original gate clock signal CKV are shifted adjacent to the 3n+1th pulse, and the output-enable signal OE turns off at the 3n−1th and the 3nth pulse. Thus, the 3n−1th and the 3nth scanlines do not display the blank data and the 3n−2th scanline can turn on long enough for the liquid crystal capacitor to react to the blank data. In addition, the scanlines utilized for generating the display area 22 are all turned on to display the image. FIG. 8 illustrates the condition of the 3n−1th frame, and FIG. 9 illustrates the condition of the 3nth frame. In the 3n−1th frame, the pulses before the second pulse of the gate clock signal CKV can be neglected, and in the 3nth frame the pulses before the third pulse of gate clock signal CKV can be neglected, since the output-enable signal OE turns off before the second and third pulse.

In summary, when a low-resolution image is shown on a high-resolution display panel, line buffers are required to display the blank area of the display panel. The fewer line buffers utilized, the less hardware required, but the response time of the liquid crystal capacitor should also be taken into consideration. Therefore, the present invention provides a method for utilizing a plurality of frames to display an image of low resolution on a display device of high resolution, displaying a first area comprising the image of a first frame by turning on all scanlines utilized for generating the image, and displaying a second area of the first frame by turning on a part but not all of the scanlines not utilized for displaying the image. To display the low-resolution image on the high-resolution display panel, the blank areas of the display panel are displayed in multiple frames, so that the liquid crystal capacitor can have enough time to respond without adding more line buffers.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for displaying a low-resolution image on a high-resolution display panel comprising:
displaying a first area comprising the image of a first frame by turning on all scanlines utilized for generating the image; and
displaying a second area of the first frame by turning on a part but not all of the scanlines not utilized for generating the image;
wherein the first area of the first frame and the second area of the first frame do not overlap.

2. The method of claim 1 further comprising:
displaying a first area comprising the image of a second frame by turning on all scanlines utilized for generating the image; and
displaying a second area of the second frame by turning on a part but not all of the scanlines not utilized for generating the image;
wherein the first area of the second frame and the second area of the second frame do not overlap.

3. The method of claim 2, wherein displaying the second area of the second frame by turning on the part but not all of the scanlines is turning on remaining scanlines not utilized for generating the image to display a remaining area in the second frame.

4. The method of claim 2, wherein displaying the second area in the first frame by turning on the part but not all of scanlines not utilized for generating the image is turning on odd scanlines not utilized for generating the image to display the second area in the first frame, and displaying the remaining area in the second frame by turning on the part but not all of the scanlines not utilized for generating the image is turning on even scanlines not utilized for generating the image to display the second area in the second frame.

5. The method of claim 2, wherein displaying the second area in the first frame by turning on the part but not all of the scanlines not utilized for generating the image is turning on even scanlines not utilized for generating the image to display the second area in the first frame, and displaying the second area in the second frame by turning on the part but not all of the scanlines not utilized for generating the image is turning on odd scanlines not utilized for generating the image to display the remaining area in the second frame.

6. The method of claim 2 further comprising:
displaying a first area comprising the image of a third frame by turning on all of the scanlines utilized for generating the image; and
displaying a second area in the third frame by turning on a part but not all of the scanlines not utilized for generating the image;
wherein the first area of the third frame and the second area of the third frame do not overlap.

7. The method of claim 6, wherein displaying the second area in the third frame by turning on the part but not all of the scanlines not utilized for generating the image is turning on remaining scanlines not utilized for generating the image to display a remaining area in the third frame.
